(19) United States
(12) Patent Application Publication
(10) Pub. No.: US 2012/0105680 A1
(43) Pub. Date: May 3, 2012

(54) SOC STRUCTURE OF VIDEO CODEC-EMBEDDED IMAGE SENSOR AND METHOD OF DRIVING IMAGE SENSOR USING THE SAME

(75) Inventor: Dong Jo PARK, Yongin (KR)

(73) Assignee: HYNIX SEMICONDUCTOR INC., Icheon-si (KR)

(21) Appl. No.: 13/285,164

(22) Filed: Oct. 31, 2011

(30) Foreign Application Priority Data
Nov. 2, 2010 (KR) 10-2010-0108305

(51) Int. Cl. H04N 5/225

(52) U.S. Cl. 348/231.99; 348/222.1; 348/E05.024

(57) ABSTRACT

A system on chip (SoC) structure of a video codec-embedded image sensor and a method of driving an image sensor using the same are provided. The image sensor includes a first domain including a codec processing unit processing image data using a video codec and a core processor, a second domain including an image sensor pixel and an analog-to-digital converter (ADC), a third domain including an image signal processor (ISP) performing signal processing on the image data obtained from the second domain, a fourth domain including a formatter converting a data format of the data generated in the first to third domains to the outside, an a clock generation unit providing system clocks to the first to fourth domains, respectively.

### CROSS-REFERENCE TO RELATED APPLICATIONS

This application claims priority to Korean Patent Application No. 10-2010-0108305 filed on Nov. 2, 2010 in the Korean Intellectual Property Office, the disclosure of which is incorporated herein by reference in its entirety.

### BACKGROUND OF THE INVENTION

1. Field of the Invention

The present invention relates generally to a system on chip (SoC) structure of a video codec-embedded image sensor and a method of driving an image sensor using the same, and more particularly to a structure for implementing an image sensor including a codec which can support video encoding and decoding, as an SoC, and a method for driving an image sensor using the structure.

2. Description of the Related Art

A typical system on chip (SoC) type CMOS image sensor (CIS) merely supports image signal processing and the so-called “3A” (Auto White Balance, Auto Exposure, Auto Focus) and pixel readout functions.

However, as the H.264 and MPEG-4 encoding and decoding functions are implemented in mobile terminals and automobile applications, implementing a typical SoC type CIS described above in a video system is problematic because, to do so, a CIS chip would be required in addition to a video codec chip for encoding the CIS output image data into a commercial video format such as H.264/MPEG-4.

An additional chip in a video system imposes unfavorable constraints such as lengthened development time, additional costs, technical difficulties of modularization, etc.

### SUMMARY OF THE INVENTION

An aspect of the present invention provides a system on chip (SoC) structure of a video codec-embedded image sensor and a method of driving an image sensor using the same, in particular, provides a structure for integrating a video codec in an image sensor and a method for driving the image sensor implemented to have the structure.

According to an aspect of the present invention, there is provided a video codec-embedded image sensor including: a first domain codec-processing image data using a video codec and controlling an overall operation of the image sensor; a second domain receiving an image signal as a light signal and generating image data as a digital electrical signal; a third domain performing signal-processing on the image data obtained from the second domain; a fourth domain converting a data format of the data generated in the first to third domains so as to be output to the outside, and outputting the data to the outside; and a clock generation unit providing a system clock to each of the first to fourth domains through each of separate clock supply lines, wherein the first domain controls a data flow among the first to fourth domains.

The first domain may include: a codec processing unit encoding or decoding the image data according to the video codec; and a core processor controlling the operations of the first to fourth domains.

The clock generation unit may generate a first clock having a period changing according to an operational state of the first domain, and generate a second clock for the second domain, a third clock for the third domain, and a fourth clock for the fourth domain, and a first clock supply line supplying the first clock to the first domain, a second clock supply line supplying the second clock to the second domain, a third clock supply line supplying the third clock to the third domain, and a fourth clock supply line supplying the fourth clock to the fourth domain may be separated.

The operational state of the first domain may include an idle state in which the first clock is not generated when the image sensor is not in use, a low speed operational state in which the first clock is generated with a period longer than a reference period when codec encoding or decoding is not performed, a normal operational state in which the first clock is generated at the reference period when the codec processing unit performs codec encoding or decoding, and a high speed operational state in which the first clock is generated with a period shorter than the reference period when the codec processing unit and the core processor performs codec encoding or decoding.

According to another aspect of the present invention, there is provided a method for driving an image sensor which processes image data using a video codec and includes separate domains controlling the overall operation of the image sensor and clock supply lines separately connected to the domains, including: an idle operation of stopping the operation of the image sensor; and an image data obtaining operation of obtaining image data using the image sensor.

The method may further include: a codec processing operation of processing the image data obtained in the data obtaining operation using the video codec.

According to another aspect of the present invention, there is provided an image sensor including: a plurality of domains each including a device mounted therein and processing an image; and a clock generation unit providing system clocks to the plurality of domains through separate clock supply lines, wherein one of the domains includes a codec processing unit for processing image data using a video codec, and a core processor, and the clock generation unit provides a system clock at a speed corresponding to an operation speed of the device mounted in each of the plurality of domains, by domain.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram showing function blocks of a video codec-embedded image sensor demarcated by operation clock;

FIG. 2A is a view showing a flow of image data obtained in a second domain;

FIG. 2B is a view showing a flow of image data signal-processed in a third domain;

FIG. 2C is a view showing a flow of image data which are currently being processed by codec or have already been processed by codec in a first domain;

FIG. 3 is a flow chart illustrating an operational process of a method for driving a video codec-embedded image sensor according to an embodiment of the present invention; and

FIG. 4 is a view showing the relationship between respective operational operations of the method for driving the video codec-embedded image sensor according to an embodiment of the present invention and the speed of clocks provided to the first domain.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like components.

Throughout the specification and claims, unless explicitly described to the contrary, the word “comprise” and variations such as “comprises” or “comprising”, will be understood to imply the inclusion of stated elements but not the exclusion of any other elements.

The problems that may arise in a two-chip video system are briefly described below.

The two chips in a video system according to H.264/MPEG-4 refer to a CIS sensor chip and a backend processor chip. The CIS sensor chip produces a CIS image, and the backend processor chip video encodes the received CIS image and stores and outputs the encoded image signal to a display device. There are certain problems associated with modularizing these two chips into a single module such as interface and firmware mismatch between the CIS sensor and the backend processor. Also, increasing the module area to mount the two chips increases the overall fabrication cost of the module, where the high cost would act to degrade the marketability of the fabricated module.

Furthermore, the CIS system and the codec processing module system have different operational schemes, and, due to this and other differences, simply integrating the CIS and codec processing modules into a single chip does not provide a solution to many problems related to power controlling, interfacing, etc.

Thus, it is required to have an SoC structure that allows such heterogeneous systems to coexist in a single chip and provides a way for controlling the heterogeneous systems in the single chip structure.

The function blocks configured to perform both CIS and codec processing in a single chip and the operations between the function blocks are described below according to an embodiment of the present invention.

The function blocks integrated in one chip to perform both CIS and codec processing include: a core processor, a pixel read-out circuit, an image signal processor (ISP), and a codec processing unit. Also, it may be possible to utilize a formatter outputting image data to the outside and a direct memory access (DMA) and a bus to transmit data between the function blocks.

If necessary, a storage device storing image data may be provided.

The pixel read-out circuit includes an image sensor pixel such as a CMOS or the like. An image data obtained from each image sensor pixel is outputted through the pixel read-out circuit.

The output data from the pixel read-out circuit may be transferred to the ISP. The ISP may perform the image signal processing on the image data (such as the “3A” for Auto White Balance, Auto Exposure, and Auto Focus) and output the image signals.

It is possible that the image data outputted from the pixel read-out circuit may be transferred directly to the codec processing unit. Alternatively, it is also possible that the image data outputted form the pixel read-out circuit may be processed by the ISP prior to being transferred to the codec processing unit. The codec processing unit may encode the received image data using a video codec. Also, the codec processing unit may decode encoded image data inputted from the outside.

The image outputted from the pixel read-out circuit may be signal-processed directly by the ISP or may be processed by the codec processing unit and outputted through a formatter, and may be stored in a storage device.

In the process of transferring the image data, a direct memory access (DMA) and a bus may be used.

The function blocks integrated in the SoC configured for the CIS and codec processing mode as well as the operations and transmission data between the respective functional blocks have been described above. Hereinafter, an SoC structure related to the operations of and data transmission between the function blocks within the SoC and a method for driving the same according to an embodiment of the present invention will be described.

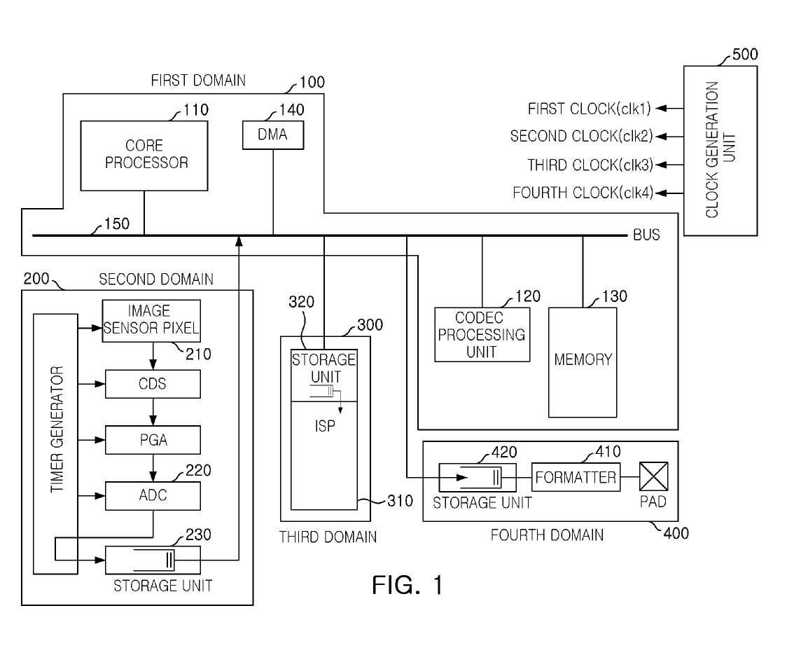

FIG. 1 is a schematic block diagram showing the function blocks of a video codec-embedded image sensor demarcated by an operation clock according to an embodiment of the present invention.

With reference to FIG. 1, the video codec-embedded image sensor according to an embodiment of the present invention may include first to fourth domains 100 to 400 and a clock generation unit 500.

The first domain 100 may process image data using a video codec and control the operation of the overall image sensor. The first domain 100 may include a codec processing unit 120 encoding or decoding image data according to a video codec and a core processor 110 controlling the first to fourth domains 100 to 400.

Also, the first domain 100 may further include a DMA 140 and a bus 150 for a data transmission between the first to fourth domains and a data transmission between the units in the first domain. If necessary, the first domain 100 may further include a memory 130 storing data. Also, if necessary, the first domain 100 may further include one or more controllers (not shown) for storing data in an external storage device.

The second to fourth domains 200 to 400 may be connected to the bus 150.

Also, the codec processing unit 120 and the core processor 110 of the first domain 100 may be connected to the bus 150, and the memory 130 of the first domain 100 may be further connected to the bus 150.

The core processor 110 may control function blocks within the first to fourth domains 100 to 400. Also, the core processor 110 may support video codec encoding and decoding in a software-wise manner (i.e., by software).

The codec processing unit 120 includes a hardware core processor processing image data using a video codec. The codec processing unit 120 may encode image data and decode encoded image data.

The DMA 140 is a device responsible for handling a data transmission between two different function blocks. The DMA 140 may read data from a first device and transfer the read data to a second device. Also, for a data transmission between a plurality of devices, the DMA 140 may read temporarily stored data from the first data and temporarily store the read data in the second device. Thus, the first and/or second device may further include a storage unit for temporarily storing input/output data. The storage unit may be implemented to be first input first output (FIFO).

The second domain 200 includes an image sensor pixel 210 and an analog-to-digital converter (ADC) 220, and may further include a pixel read-out circuit (e.g., a CDS, a PGA, or the like) for outputting image data from the image sensor pixel 210.

The image sensor pixel 210 may include optical sensing pixels such as a CCD, a CMOS, or the like. The image sensor pixel 210 converts a light signal into an electrical signal.

The ADC 220 converts an analog signal outputted from the image sensor pixel 210 or the pixel read-out circuit into a digital signal.

Also, the second domain may further include a storage unit 230 for supporting a data transmission using the DMA 140. The storage unit 230 may be connected to the bus 150.

The third domain 300 includes an image signal processor (ISP) 310 performing signal processing on image data obtained from the second domain 200. Also, the third domain 300 may further include a storage unit 320 supporting a data transmission using the DMA 140. The storage unit 320 may be connected to the bus 150.

The fourth domain 400 includes a formatter 410 converting a data format in order to output data generated in the first to third domains 100 to 300 to the outside. The fourth domain 400 may further include a storage unit 420 supporting a data transmission using the DMA 140. The storage unit 420 may be connected to the bus 150.

The clock generation unit 500 may provide a system clock to each of the first to fourth domains 100 to 400 through a separated clock supply line.

The clock generation unit 500 generates first to fourth clocks clk1 to clk4, and the first to fourth clocks clk1 to clk4 are provided to the first to fourth domains 100 to 400, respectively. Preferably, a first clock supply line providing the first clock clk1 to the first domain 100, a second clock supply line providing the second clock clk2 to the second domain 200, a third clock supply line providing the third clock clk3 to the third domain 300, and a fourth clock supply line providing the fourth clock clk4 to the fourth domain 400 may be separated.

Whereas the periods of the second to fourth clocks clk2 to clk4 may be pre-set, the period of the first clock clk1 may be variable and can be changed according to the operational states of the first domain 100.

The operational states of the first domain 100 include an idle state, a low speed operational state, a normal operational state, and a high speed operational state. An idle state refers to a state in which the first clock clk1 is not generated when the image sensor is not in use. The low speed operational state refers to a state in which the first clock clk1 is generated with a period longer than a reference period when codec encoding or decoding is not performed. The normal operational state refers to a state in which the first clock clk1 is generated at the reference period when the codec processing unit performs codec encoding or decoding. The high speed operational state refers to a state in which the first clock clk1 is generated with a period shorter than the reference period when the codec processing unit and the core processor performs codec encoding or decoding. Table 1 below shows the operational states of the first domain according to an operation scenario of the first domain.

TABLE 1

| Operation scenario | First clock |
|---|---|
| HW codec + SW codec | High speed |
| HW codec | Normal |
| HW/SW codec in standby | Low speed |
| CIS in standby/ready | Clock off |

The first to fourth clocks clk1 to clk4 generated in the clock generation unit 500 may not be synchronized clock signals, and their clock periods may be different from each other. Thus, the first to fourth domains 100 to 400 may operate asynchronously.

Thus, the first to fourth domains 100 to 400 may independently operate and their power may be independently controlled. Also, interfacing between the first to fourth domains 100 to 400 may be resolved using an asynchronous data transmission scheme using the DMA or the like.

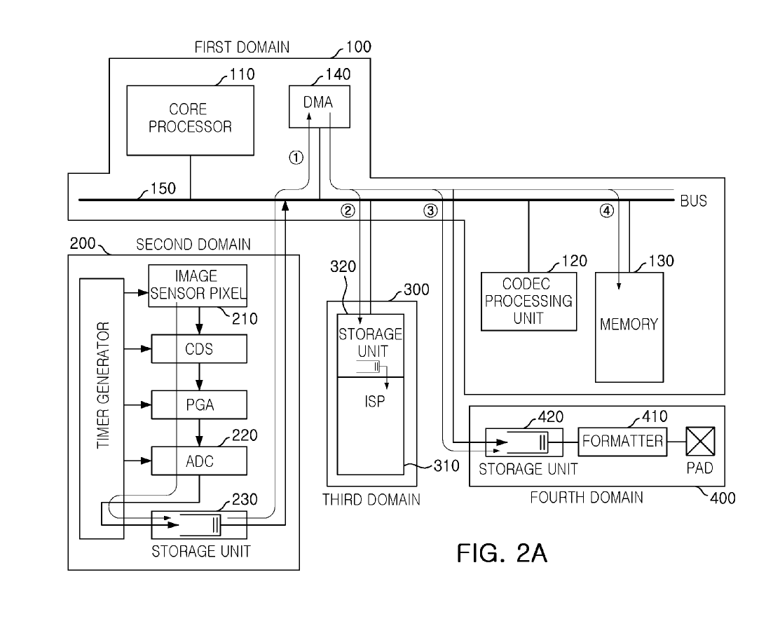

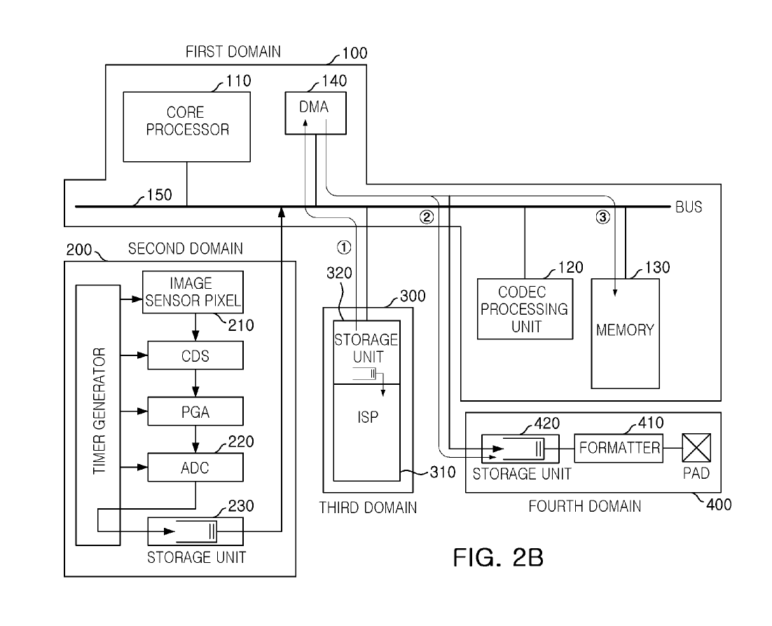

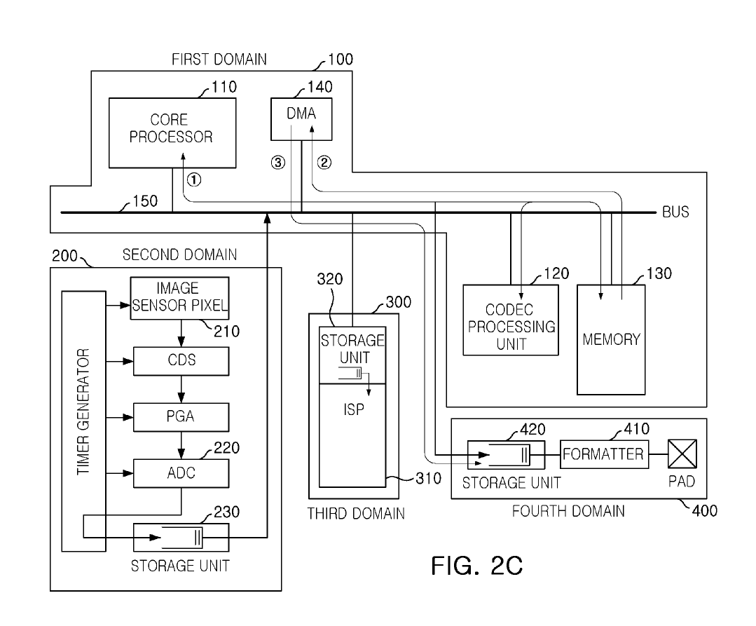

FIGS. 2A to 2C are views showing a data flow of the video codec-embedded image sensor according to an embodiment of the present invention.

FIG. 2A shows a processing flow of an image data produced in the second domain 200 according to an embodiment of the present invention.

With reference to FIG. 2A, the DMA 140 is configured to transfer an image data obtained by the image sensor pixel 210 of the second domain 200 to any one or more of the other domains such as the first, third, and fourth domains 100, 300, and 400.

The image data in the image sensor pixel 210 of the second domain 200 may be outputted to the ADC 200 by a pixel read-out circuit (e.g., the CDS or the PGA). The ADC 220 is configured to convert the obtained image data into a digital signal and store the converted digital signal in the storage unit 230.

The DMA 140 is capable of temporarily reading the image data stored in the storage unit 230 of the second domain 200 through the bus 150 and temporarily storing the read image data. The DMA 140 may store the temporarily stored image data through the bus 150 in one or more of storage media such as the storage unit 320 of the third domain 300, the storage unit 420 of the fourth domain 400, and the memory 130 of the first domain 100.

FIG. 2B shows a process flow of an image data signal-processed in the third domain 300 according to an embodiment of the present invention.

With reference to FIG. 2B, the image data signal-processed in the ISP 310 may be transferred to other domains such as to the first or fourth domain 100 or 400 by the DMA 140.

The ISP 310 of the third domain 300 may read the image data stored in the storage unit 320 and process the read data. In general, the ISP unit 310 of the third domain 300 may perform image signal processing functions such as one or more of the “3A” functions for Auto White Balance, Auto Exposure, and Auto Focus. The ISP 310 may store the signal-processed image data again in the storage unit 320.

The DMA 140 may read the image data stored in the storage unit 320 of the third domain 300 through the bus 150 and temporarily store the read image data therein. The DMA 140 may store the temporarily stored image data in the storage unit 420 of the fourth domain 400 and the memory 130 of the first domain through the bus 150.

FIG. 2C a process flow example of image data that is being or was processed by a codec in the first domain according to an embodiment of the present invention.

With reference to FIG. 2C, the codec processing unit 120 may access the memory 130 to codec-process the image data stored in the memory 130 and to store the codec-processed image data in the memory 130. The codec-processed image data may be transferred to the fourth domain 400. Or, when needed, the core processor 100 may perform the operation along with the codec processing unit 120.

The codec processing unit 120 is configured to read the image data stored in the memory 130, encode the read image data according to a video codec, or decode the encoded image data stored in the memory 130. The core processor 110 may read the image data stored in the memory 130 and encode the read image data by software according to the video codec or decode the encoded image data stored in the memory 130 by software.

When needed, the DMA 140 may control an image transmission between the core processor 110, the codec processing unit 120, and the memory 130. The DMA 140 may read the image data stored in the memory 130 and transfer the read image data to the core processor 110 or the codec processing unit 120, and the DMA 140 may also read the image data processed in the processor 110 or the codec processing unit 120 and store the read image data in the memory 130.

Also, the DMA 140 may read the image data processed in the processor 110 or the codec processing unit 120 or the codec-processed data stored in the memory 130 and store the read data in the storage unit 410 of the fourth domain 400.

The fourth domain 400 converts the data format of the image data stored in the storage unit 420 using the formatter 410 and outputs the format-converted image data to the outside.

The core processor 110 may process the audio codec. Thus, the core processor 110 can support video and audio coding by, for example, a software to reproduce a multimedia file. Also, a hardware accelerator may be connected to the bus 150 to perform channel coding on the image data or the like. Thus, it should be readily understood that the functions can be easily added according to usage according to an embodiment of the present invention.

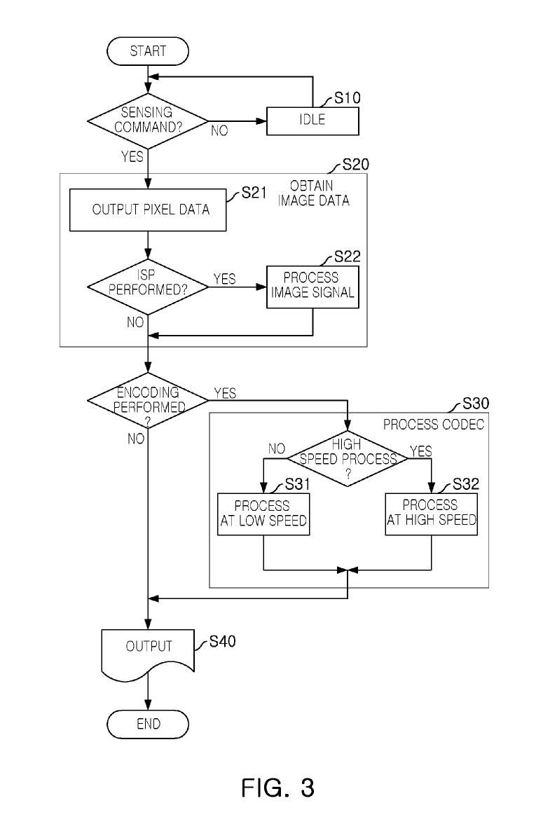

FIG. 3 is a flow chart illustrating the process of driving a video codec-embedded image sensor according to an embodiment of the present invention;

The method for driving a video codec-embedded image sensor according to an embodiment of the present invention may use an image sensor having a demarcated domain processing image data using a video codec and controlling an overall operation of the image sensor and separated clock supply lines connected to the domain.

Referring to FIG. 3, a method of driving a video codec-embedded image sensor according to an embodiment of the present invention may include, inter alia: an idle operation S10, an image data obtaining operation S20, a codec processing operation S30, and an output operation S40.

In the idle operation S10, the image sensor wait for an image sensing command or may not begin the operation.

When an image sensing command is received, the process proceeds to the image data obtaining operation S20 to obtain an image by operating the second domain of the image sensor. In the pixel data outputting operation S21, the image signal as a light signal in the image sensor pixel 210 is converted into an electrical signal, and the converted image signals are output as image data.

When an ISP performing command is received, an image signal processing operation S22 is performed. In the image signal processing operation S22, image signal processing such as 3A or the like may be performed.

When there is no ISP performing command, the codec processing operation S30 or the output operation S40 may be performed.

Also, the method of driving a video codec-embedded image sensor may use an image sensor, in which the demarcated domain includes a codec processing unit for encoding or decoding image data according to a video codec, a core processor for controlling the operation of the image sensor, and a data transmission unit for controlling and performing a data transmission within the image sensor.

When an encoding command is received, the codec processing operation S30 is performed by determining whether a high speed encoding processing is to be performed. When a high speed encoding processing is determined to be performed, a high speed processing operation S32 is performed, but when a high speed encoding processing is determined as not to be performed, a low speed processing operation S31 is performed. In the low speed processing operation S31, the codec processing unit 120 may only be operated to encode the image data by, for example, hardware or in a hardware-wise manner, but, in the high speed processing operation S32, the core processor 110 as well as the codec processing unit 120 encode the image data by, for example, software.

When there is no encoding command, the output operation S40 may be performed.

In the output operation S40, the image data is converted according to an output format and then outputted to an external device.

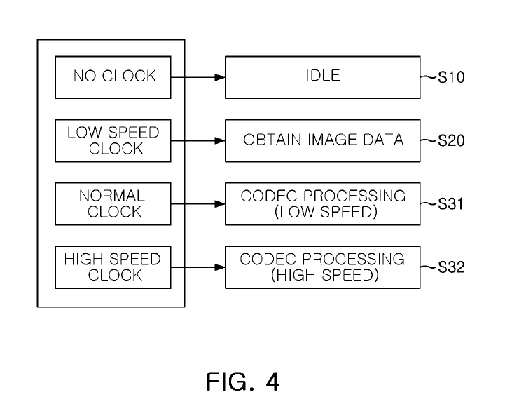

FIG. 4 shows the clock speeds provided to the first domain with respect to the operations performed for driving the video codec-embedded image sensor according to an embodiment of the present invention.

With reference to FIG. 4, the clocks provided to the first domain 100 may have different speeds according to the different operational stages.

In an idle state S10, a driving clock may not be provided so as to stop the operation of the first domain 100 of the image sensor in order to prevent power consumption (e.g., clk1). Also, according to an embodiment of the present invention, a portion or the entire amount of the power provided to the domains 100 to 400 of the image sensor may be cut off.

In an image data obtaining operation S20, the first domain 100 of the image sensor may serve to control the operations of the second or third domain 200, 300 and a data flow, so a low speed clock may be supplied to the first domain 100. Also, the second or third clock clk2, clk3 with a pre-set period may be provided to the second or third domain 200, 300.

In a low speed processing operation S31 of the codec processing operation S30, a normal clock is provided to the first domain 100 of the image sensor. In a high speed processing operation S32 of the codec processing operation S30, a high speed clock may be provided to the first domain 100 of the image sensor. This is because, in the case of high speed processing operation S32, both the codec processing unit 120 and the core processor 110 perform the codec processing; thus, a faster data transmission and faster operation of function blocks are required.

As set forth above, the SoC structure of a video codec-embedded image sensor and the method of driving an image sensor using the same according to various embodiments of the invention are advantageous in that it would be possible to sense an image using a single chip set, and the sensed image data can be encoded into a commercial compression format such as H.264/MPEG-4 or the like with relative ease.

In the SoC structure of a video codec-embedded image sensor and the method of driving an image sensor using the same according to various embodiments of the invention, the single chip implementation of the image sensor and the codec processing unit provides effective solutions to the system operational difficulties related to, for example, the mismatching firmwares of the image sensor and the codec processing unit that are implemented as two separate chips.

In the SoC structure of a video codec-embedded image sensor and the method of driving an image sensor using the same according to various embodiments of the present invention, the single chip implementation of the image sensor and the codec processing unit leads to reduced mounting area and thus can reduce the manufacturing cost and enhance the marketability of the manufactured product.

While the present invention has been shown and described in connection with the embodiments, it will be apparent to those skilled in the art that modifications and variations can be made without departing from the spirit and scope of the invention as defined by the appended claims.

What is claimed is:

1. An image sensor comprising:
a second domain configured to generate a digital signal image data from a light signal representing an image;
a first domain configured to perform codec-processing on the image data using a video codec;
a third domain configured to perform signal-processing on the image data from the second domain;
a fourth domain configured to convert data format of the data generated in the first, second, and third domains and output the converted data; and
a clock generation unit configured to provide a system clock to each of the first, second, third, and fourth domains through separate clock supply lines,
wherein the first domain is capable of controlling a data flow between the first, second, third, and fourth domains.

2. The image sensor of claim 1, wherein the first domain comprises:
a codec processing unit configured to encode or decode the image data according to the video codec; and
a core processor configured to control the operations of the first, second, third, and fourth domains.

3. The image sensor of claim 2, further comprising:
a bus configured to transmit data between the first, second, third, and fourth domains,
wherein the first domain further comprises a data transmission unit configured to perform data transmission between the first, second, third, and fourth domains.

4. The image sensor of claim 3, wherein each of the second, third, and fourth domains further comprises a storage unit for storing input and output data,
wherein the storage unit in each of the second, third, and fourth domains is connected to the bus, and
wherein the data transmission unit is capable of reading the data stored in the storage unit in any of the second, third, and fourth domains and storing the read data in the storage unit of a different domain.

5. The image sensor of claim 2, wherein the first domain further comprises a memory device storing data and connected to the bus.

6. The image sensor of claim 2, wherein the codec processing unit comprises a co-processor for video encoding and video decoding.

7. The image sensor of claim 1, wherein the clock generation unit is configured to generate a plurality of clocks comprising:
a first clock having a period changing according to an operational state of the first domain;
a second clock for the second domain;
a third clock for the third domain; and
a fourth clock for the fourth domain, and wherein the clock generation unit comprises:
a first clock supply line supplying the first clock to the first domain;
a second clock supply line supplying the second clock to the second domain;
a third clock supply line supplying the third clock to the third domain; and
a fourth clock supply line supplying the fourth clock to the fourth domain are separated.

8. The image sensor of claim 7, wherein the first domain is configured to operate in each of the operating states comprising:
an idle state in which the first clock is not generated when the image sensor is not in use;
a low speed operational state in which the first clock is generated with a period longer than a reference period when codec encoding or decoding is not performed;
a normal operational state in which the first clock is generated at the reference period when the codec processing unit performs codec encoding or decoding; and
a high speed operational state in which the first clock is generated with a period shorter than the reference period when the codec processing unit and the core processor performs codec encoding or decoding.

9. The image sensor of claim 7, wherein each of the second, third, and fourth clocks is generated at a pre-set period, respectively.

10. The image sensor of claim 2, wherein the codec processing unit comprises a hardware module implementing a video codec, and the core processor comprises a processor configured to perform codec-processing by software.

11. A method of driving an image sensor comprising a demarcated domain configured to control the image sensor and clock supply lines connected to the demarcated domain, the method comprising:
performing an idle operation comprising stopping the operation of the image sensor; and
obtaining an image data using the image sensor.

12. The method of claim 11, wherein the step of obtaining image data comprises:
reading an image data value stored in the pixels; an
performing signal-processing on the image data value so as to obtain the image data.

13. The method of claim 12, wherein operation clocks provided to the clock supply lines comprise:
an idle clock for not providing the operation clock in the idle operation; and
a low speed clock for generating the operation clock with a period longer than a pre-set reference period and for providing the generated operation clock in the step of obtaining the image data.

14. The method of claim 12, wherein the demarcated domain comprises:
a codec processing unit configured to encode or decode the image data according to a video codec;
a core processor configured to control the image sensor; and
a data transmission unit configured to control data transmission in the image sensor.

15. The method of claim 11, further comprising:
performing a codec processing operation to process the image data using the video codec.

16. The method of claim 15, wherein the step of performing codec processing operation comprises:
performing a low speed processing operation, wherein the codec processing is performed by the codec processing unit; and
performing a high speed processing operation, wherein the codec processing is performed by the codec processing unit and the core processor.

17. The method of claim 16, wherein the operation clocks supplied to the clock supply lines comprise:
an idle clock for not providing the operation clock in the idle operation;
a low speed clock for generating the operation clock with a period longer than a pre-set reference period and for providing the generated operation clock in the step of obtaining the image data;
a normal clock for generating the operation clock with the reference period and for providing the generated operation clock in the step of performing low speed processing operation; and
a high speed clock for generating the operation clock with a period shorter than the reference period and for providing the generated operation clock in the step of performing high speed processing operation.

18. The method of claim 16, wherein the operation clocks are generated by a dividing circuit in the image sensor, and wherein the operation clocks are generated according to the operational status of the processor of the demarcated domain.

19. The method of claim 16, wherein the demarcated domain comprises:
a codec processing unit configured to encode or decode the image data according to a video codec;
a core processor configured to control the image sensor; and
a data transmission unit configured to control data transmission in the image sensor.

20. An image sensor comprising:
a plurality of domains, each comprising a device configured to process an image; and
a clock generation unit configured to provide system clocks to the plurality of domains through separate clock supply lines,
wherein one of the domains comprises:
a codec processing unit for processing image data using a video codec; and
a core processor, and
wherein the clock generation unit provides a system clock at a speed corresponding to an operation speed of the device in each of the plurality of domains.
